(19) United States
(12) Patent Application Publication
(10) Pub. No.: US 2017/0293323 A1
(43) Pub. Date: Oct. 12, 2017

(54) ELECTRONIC DEVICE

(71) Applicant: Quanta Computer Inc., Taoyuan City (TW)

(72) Inventors: Chih-Jen HUANG, Taoyuan City (TW); Chien-Fu CHEN, Taoyuan City (TW)

(21) Appl. No.: 15/177,950

(22) Filed: Jun. 9, 2016

(30) Foreign Application Priority Data
Apr. 6, 2016 (TW) 105204676

(51) Int. Cl. G06F 1/16

(52) U.S. Cl. CPC G06F 1/1679; G06F 1/1626; G06F 1/1686; G06F 1/1688; G06F 1/1698; G06F 1/1677

(57) ABSTRACT

An electronic device is provided, including a housing having a side wall, a display panel, a push latch, a video/audio transceiver, and an elastic member, wherein the display panel is disposed in the housing. The push latch is fixed on the housing. The video/audio transceiver is movably disposed in the housing, and has a connecting portion. The elastic member connects the video/audio transceiver with the housing. When the connecting portion is connected to the push latch, the video/audio transceiver is in a first position. When the connecting portion is separated from the push latch, the video/audio transceiver moves from the first position to a second position and protrudes from the side wall due to the elastic force of the elastic member.

### CROSS REFERENCE TO RELATED APPLICATIONS

The present application is based on, and claims priority from, Taiwan Patent Application No. 105204676, filed on Apr. 6, 2016, the disclosure of which is hereby incorporated by reference herein in its entirety.

### BACKGROUND OF THE INVENTION

### Field of the Invention

The application relates in general to an electronic device, and in particular, to an electronic device having a video/audio transceiver.

### Description of the Related Art

The current trend of electronic devices having a display panel (for example, in tablet computers or smartphones) is moving towards large screens and easy storage, so that the width of the bezel of some electronic devices is reduced. A camera or microphone is generally disposed in the bezel, however when the width of the bezel is reduced, the camera or the microphone cannot be accommodated therein. Therefore, how to dispose the camera and the microphone in the electronic device having a thin bezel has become a critical issue.

### BRIEF SUMMARY OF INVENTION

To address the deficiencies of conventional products, an embodiment of the invention provides an electronic device, including a housing having a side wall, a display panel, a push latch, a video/audio transceiver, and an elastic member, wherein the display panel is disposed in the housing. The push latch is fixed on the housing. The video/audio transceiver is movably disposed in the housing, and has a connecting portion. The elastic member connects the video/audio transceiver with the housing. When the connecting portion is connected to the push latch, the video/audio transceiver is in a first position. When the connecting portion is separated from the push latch, the video/audio transceiver moves from the first position to a second position and protrudes from the side wall due to the elastic force of the elastic member.

In some embodiments, the housing further comprises a guiding portion, and the video/audio transceiver is slidably connected to the guiding portion.

In some embodiments, the guiding portion comprises a guiding slot.

In some embodiments, the guiding portion comprises a pillar.

In some embodiments, the elastic member surrounds the pillar.

In some embodiments, the video/audio transceiver further comprises a gear rack, and the electronic device further comprises a speed-reduction assembly. The speed-reduction assembly comprises a hollow member, a damping fluid, and a gear. The hollow member is fixed on the housing. The damping fluid is accommodated in the hollow member. The gear is engaged with the gear rack and contacts the damping fluid.

In some embodiments, the electronic device further comprises a stopper, fixed on the housing. When the video/audio transceiver is in a first position, the video/audio transceiver contacts or is adjacent to the stopper.

In some embodiments, the electronic device further comprises a detector and a circuit unit, and the circuit unit is electrically connected to the detector and the video/audio transceiver. When the detector detects that the video/audio transceiver is in the first position, the detector transmits a close signal to the circuit unit, and the circuit unit stops providing the power to the video/audio transceiver. When the detector detects that the video/audio transceiver is leaving the first position, the detector transmits an open signal to the circuit unit, and the circuit unit provides the power to the video/audio transceiver.

In some embodiments, the detector comprises a switch. When the video/audio transceiver is in the first position, the video/audio transceiver pushes the switch.

In some embodiments, when the video/audio transceiver is in the first position, a surface of the video/audio transceiver is aligned with the side wall.

In some embodiments, the housing further comprises a back cover connected to the side wall, and the video/audio transceiver is disposed between the back cover and the display panel.

In some embodiments, the elastic member comprises a compression spring or an extension spring.

In some embodiments, the video/audio transceiver comprises a camera, a microphone, or a speaker.

In some embodiments, the width of the video/audio transceiver is 5 cm-20 cm.

### BRIEF DESCRIPTION OF DRAWINGS

The invention can be more fully understood by reading the subsequent detailed description and examples with references made to the accompanying drawings, wherein:

FIG. 1 is a schematic diagram of an electronic device according to an embodiment of the invention;

FIG. 2 is a cross-sectional view along the line x-x in FIG. 1;

FIG. 3A is a schematic diagram of an external force applied on a video/audio transceiver along a first direction according to an embodiment of the invention;

FIG. 3B is a schematic diagram of the video/audio transceiver moves along a second direction according to an embodiment of the invention; and

FIG. 4 is a schematic diagram of an electronic device according to another embodiment of the invention.

### DETAILED DESCRIPTION OF INVENTION

The making and using of the embodiments of the electronic device are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood to one of ordinary skill in the art to which this invention belongs. It should be appreciated that each term, which is defined in a commonly used dictionary, should be interpreted as having a meaning conforming to the relative skills and the background or the context of the present disclosure, and should not be interpreted by an idealized or overly formal manner unless defined otherwise.

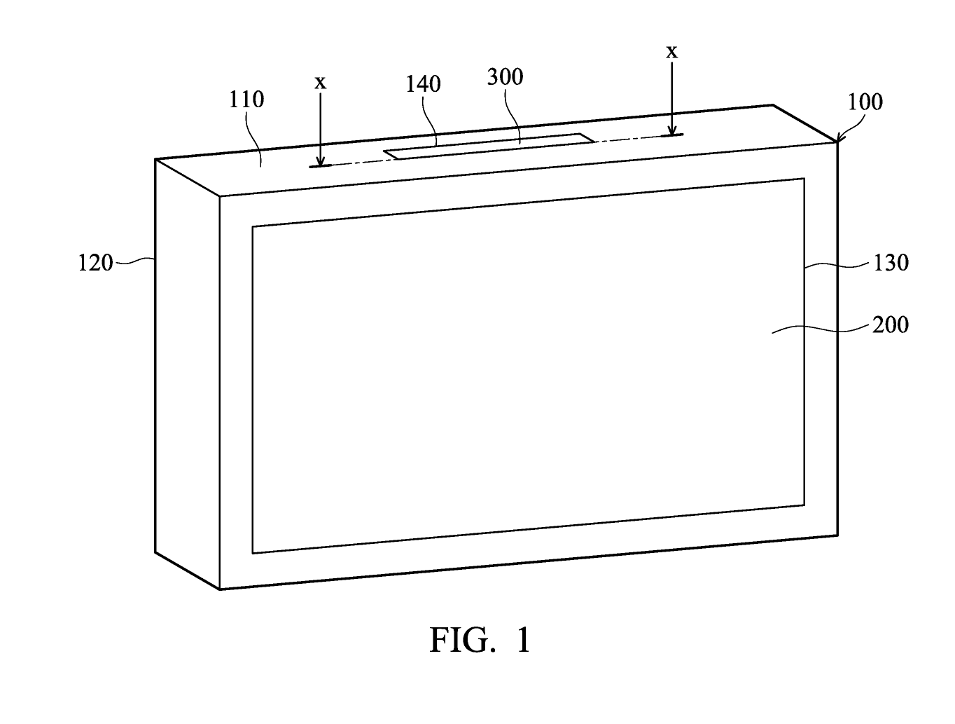

FIG. 1 is a schematic diagram of an electronic device according to an embodiment of the invention. The electronic device can be a monitor or a tablet computer, primarily comprising a housing 100, a display panel 200, and a video/audio transceiver 300. The housing 100 has a side wall 110, a back cover 120, an opening 130, and a hole 140, wherein the side wall 110 is connected to the back cover 120, and the hole 140 is formed on the side wall 110. The display panel 200 is disposed in the housing 100 and exposed through the opening 130. The user can watch the display image of the display panel 200 through the opening 130. The video/audio transceiver 300 is movably disposed in the housing 100 and is situated between the display panel 200 and the back cover 120.

The video/audio transceiver 300 can comprise a camera, a microphone, or a speaker. The video/audio transceiver 300 and the opening 130 face toward the same direction. When the user wants to use the video/audio transceiver 300, the video/audio transceiver 300 can pass through the hole 140 and protrude from the side wall 110 for receiving or sending the video/audio signal at the front of the electronic device.

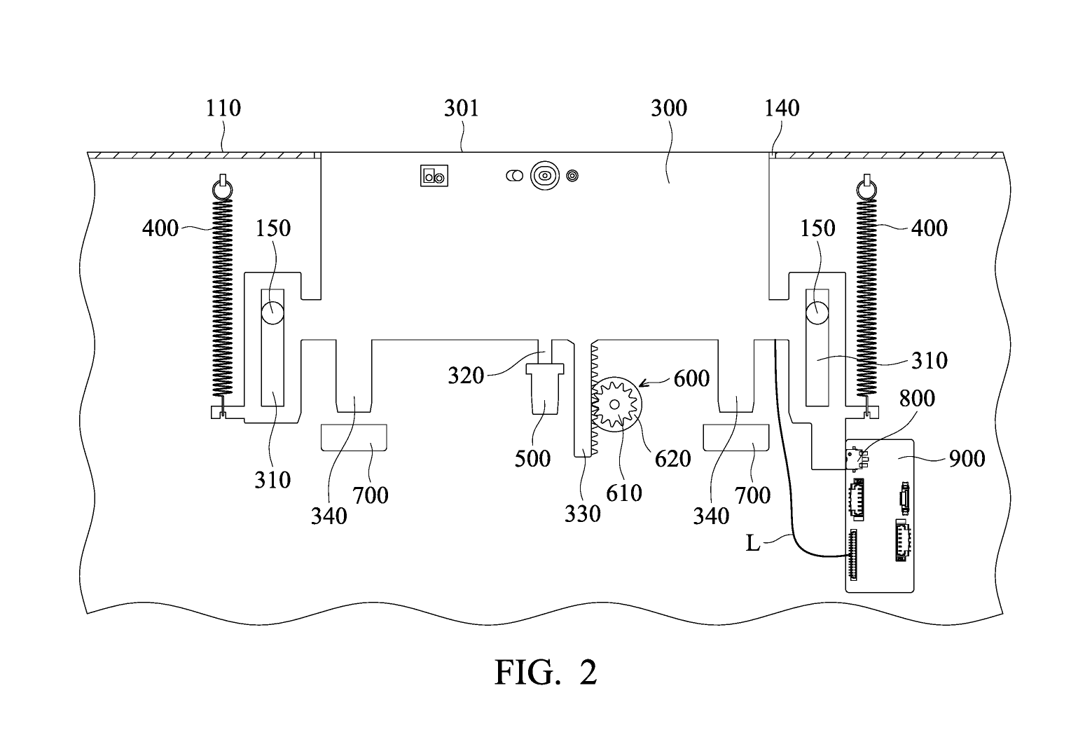

As shown in FIG. 2, the electronic device further comprises at least one elastic member 400, a push latch 500, a speed-reduction assembly 600, at least one stopper 700, a detector 800, and a circuit unit 900. In this embodiment, the elastic members 400 comprise two extension springs connected the housing 100 and the video/audio transceiver 300, and the video/audio transceiver 300 is disposed between the aforementioned two elastic members 400.

The speed-reduction assembly 600 comprises a gear 610, a hollow member 620, and damping fluid in the hollow member 620, wherein the hollow member 620 is fixed on the housing 100, and the gear 610 contacts the damping fluid. The push latch 500, the stopper 700, the detector 800, and the circuit unit 900 are fixed on the housing 100. The stoppers 700 are flexible and disposed on the positions adjacent to the right end and the left end of the video/audio transceiver 300. The detector 800 is electrically connected to the circuit unit 900. The circuit unit 900 is electrically connected to the video/audio transceiver 300 via a wire L.

Referring to FIG. 2, the video/audio transceiver 300 has two sliding portions 310, a connecting portion 320, and a gear rack 330. The sliding portion 310 is slidably connected to the guiding portion 150 of the housing 100. The connecting portion 320 is detachably connected to the push latch 500. The gear rack 330 is engaged with the gear 610 of the speed-reduction assembly 600.

In this embodiment, the sliding portion 310 is a guiding slot formed on the video/audio transceiver 300, and the guiding portion 150 is a pillar formed on the housing 100, wherein the pillar passes through the guiding slot. The longitudinal axis of the guiding slot is substantially parallel to the longitudinal axis of the elastic member 400, and the width of the pillar is substantially the same as that of the guiding slot. Therefore, the deviation of the video/audio transceiver 300 during the movement can be avoided. In some embodiments, the sliding portion 310 can be a pillar formed on the video/audio transceiver 300, and the guiding portion 150 can be a guiding slot formed on the housing 100.

As shown in FIGS. 1 and 2, when the connecting portion 320 is connected with the push latch 500, the video/audio transceiver 300 can be fixed on a first position, and a surface 301 of the video/audio transceiver 300 is aligned with the side wall 110 of the housing 100. The electronic device can achieve an integrated appearance. Furthermore, the video/audio transceiver 300 contacts or pushes a switch of the detector 800, and the detector 800 transmits a close signal to the circuit unit 900. When the close signal is received by the circuit unit 900, the circuit unit 900 stops providing power to the video/audio transceiver 300. That is, when the video/audio transceiver 300 is in the first position, the camera, the microphone, or the speaker is disabled. Moreover, the contacting portions 340 of the video/audio transceiver 300 can contact or be adjacent to the stoppers 700.

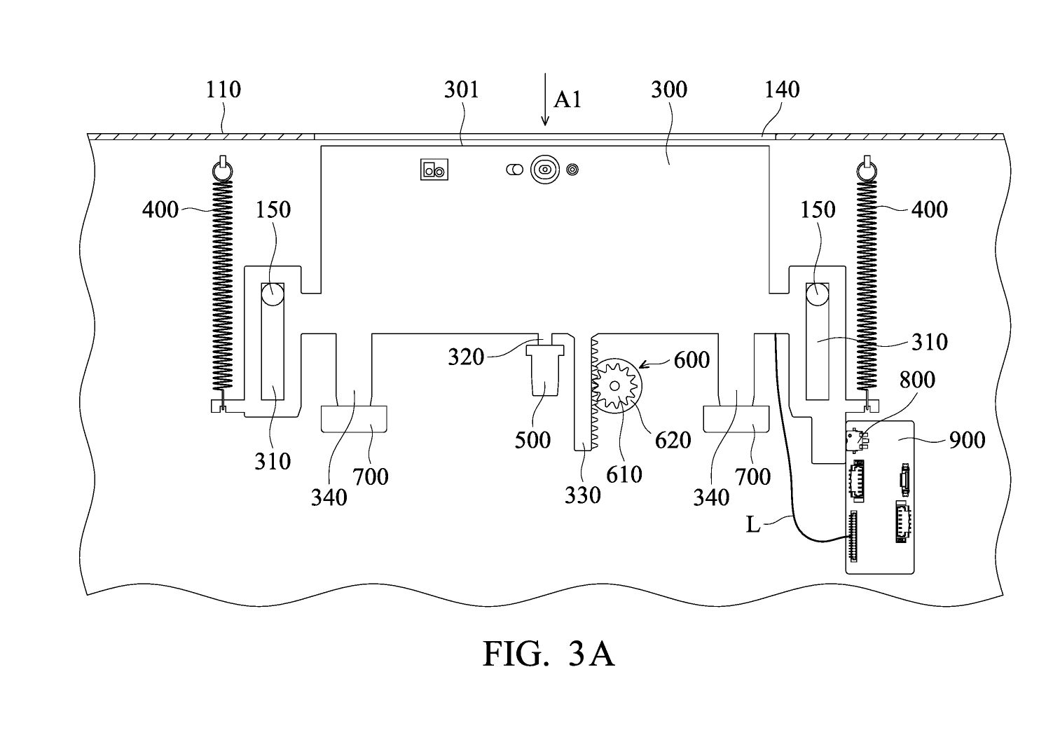

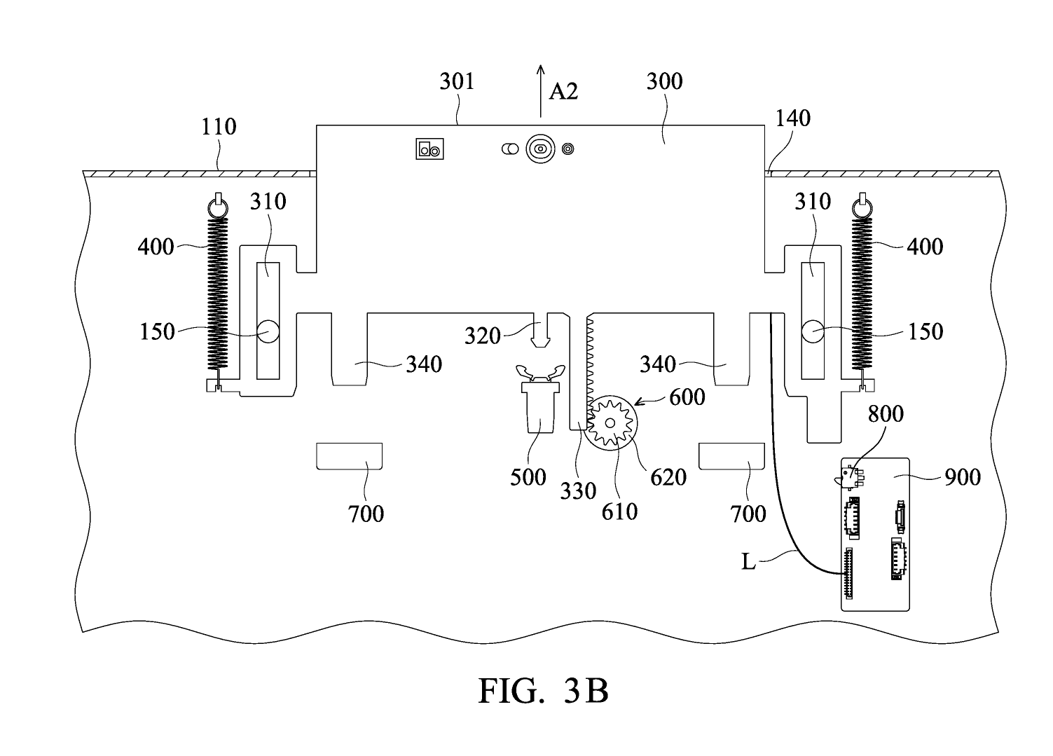

As shown in FIG. 3A, when the user wants to use the video/audio transceiver 300, he can push the video/audio transceiver 300 by an external force along a first direction A1 to release the push latch 500. It should be noted that, when the video/audio transceiver 300 is pushed, the contacting portions 340 contact the stoppers 700. Therefore, when the video/audio transceiver 700 is pushed, the stoppers 700 can prevent the video/audio transceiver 700 from inclining. The width of the video/audio transceiver 700 is 5 cm-20 cm.

As shown in FIG. 3B, when the external force is released, the video/audio transceiver 300 moves from the first position along a second direction A2 to a second position and protrudes from the side wall 110 due to the elastic force of the elastic member 400. When the video/audio transceiver 300 leaves the first position, it does not contact or push the switch of the detector, and the detector 800 transmits an open signal to the circuit unit 900. The circuit unit 900 provides power to the video/audio transceiver 300 when receiving the open signal, and the camera, the microphone, or the speaker of the video/audio transceiver 300 is enabled.

It should be noted that the speed-reduction assembly 600 can reduce the moving speed of the video/audio transceiver 300, so as to prevent breakage of the video/audio transceiver 300 in the event of hitting the housing 100.

When the video/audio transceiver 300 needs to be stored, the user can push it along the first direction Al by the external force again, and the video/audio transceiver 300 moves from the second position to the first position shown in FIG. 2. The connecting portion 320 can be connected to the push latch 500 again and the video/audio transceiver 300 can be fixed in the first position.

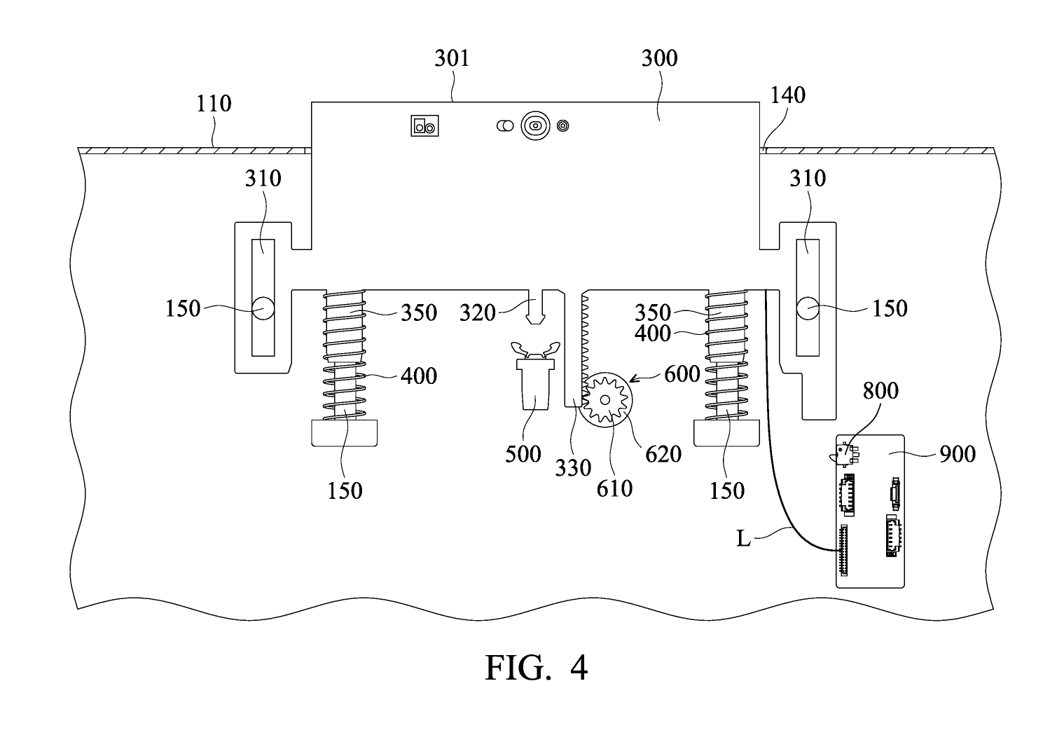

FIG. 4 is a schematic diagram of an electronic device according to another embodiment of the invention. In this embodiment, the elastic members 400 comprise two compression springs surrounding the sleeves 350 of the video/audio transceiver 300 and the pillars (guiding portions 150) of the housing 100 extending along the first direction A1. The pillar is accommodated in the sleeve 350.

In summary, an electronic device is provided. Because the video/audio transceiver is movably disposed in the housing and situated between the display panel and the back cover, the width of the bezel of the electronic device can be reduced, and an electronic device having a thin bezel can be achieved.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An electronic device, comprising:
a housing, having a side wall:
a display panel, disposed in the housing;
a push latch, fixed on the housing;
a video/audio transceiver, movably disposed in the housing and having a connecting portion; and
an elastic member, connecting the video/audio transceiver and the housing, wherein when the connecting portion is connected to the push latch, the video/audio transceiver is in a first position, wherein when the connecting portion is separated from the push latch, the video/audio transceiver moves from the first position to a second position and protrudes from the side wall due to an elastic force of the elastic member.

2. The electronic device as claimed in claim 1, wherein the housing further comprises a guiding portion, and the video/audio transceiver is slidably connected to the guiding portion.

3. The electronic device as claimed in claim 2, wherein the guiding portion comprises a guiding slot.

4. The electronic device as claimed in claim 2, wherein the guiding portion comprises a pillar.

5. The electronic device as claimed in claim 4, wherein the elastic member surrounds the pillar.

6. The electronic device as claimed in claim 1, wherein the video/audio transceiver further comprises a gear rack, and the electronic device further comprises a speed-reduction assembly, and the speed-reduction assembly comprises:
a hollow member, fixed on the housing;
a damping fluid, disposed in the hollow member; and
a gear, engaged with the gear and contacting the damping fluid.

7. The electronic device as claimed in claim 1, wherein the electronic device further comprises a stopper fixed on the housing, wherein when the video/audio transceiver is in the first position, the video/audio transceiver contacts or is adjacent to the stopper.

8. The electronic device as claimed in claim 1, wherein the electronic device further comprises a detector and a circuit unit, and the circuit unit is electrically connected the detector and the video/audio transceiver, wherein when the detector detects that the video/audio transceiver is in the first position, the detector transmits a close signal to the circuit unit, and the circuit unit stops providing power to the video/audio transceiver, wherein when the detector detects that the video/audio transceiver leaves the first position, the detector transmits an open signal to the circuit unit, and the circuit unit provides power to the video/audio transceiver.

9. The electronic device as claimed in claim 8, wherein the detector comprises a switch, wherein when the video/audio transceiver is in the first position, the video/audio transceiver pushes the switch.

10. The electronic device as claimed in claim 1, wherein when the video/audio transceiver is in the first position, a surface of the video/audio transceiver is aligned with the side wall.

11. The electronic device as claimed in claim 1, wherein the housing further comprises a back cover connected to the side wall, and the video/audio transceiver is disposed between the back cover and the display panel.

12. The electronic device as claimed in claim 1, wherein the elastic member comprises a compression spring or an extension spring.

13. The electronic device as claimed in claim 1, wherein video/audio transceiver comprises a camera, a microphone, or a speaker.

14. The electronic device as claimed in claim 1, wherein the width of the video/audio transceiver is 5 cm-20 cm.
